(19) United States
(12) Patent Application Publication
(10) Pub. No.: US 2016/0248144 A1
(43) Pub. Date: Aug. 25, 2016

(54) MAST AND RADIO ASSEMBLY FOR REMOTE OUTDOOR USE

(71) Applicant: Koos Technical Services, Inc., Lake Mary, FL (US)

(72) Inventor: Melvin Laverne Stauffer, Orlando, FL (US)

(21) Appl. No.: 15/051,533

(22) Filed: Feb. 23, 2016

Related U.S. Application Data
(60) Provisional application No. 62/119,960, filed on Feb. 24, 2015.

(51) Int. Cl. H01Q 1/12; H01Q 1/48

(52) U.S. Cl. CPC H01Q 1/1242; H01Q 1/48

(57) ABSTRACT

A mast and radio assembly includes a mast formed from one or more hollow elongate members and a radio capsule housing a radio and antenna assembly, the radio capsule completely insertable into the mast for protection from environmental conditions.

### RELATED APPLICATION DATA

This application claims the benefit of U.S. Provisional Patent Application No. 62/119,960, filed Feb. 24, 2015, the disclosure of which is incorporated herein by reference in its entirety.

### TECHNICAL FIELD OF THE INVENTION

The technology of the present disclosure relates generally to wireless communications and, more particularly, to a mast assembly that houses a radio. In a typical configuration, the radio is used to establish wireless communications between a remotely deployed sensor and a node in a network.

### BACKGROUND

Remotely taking measurement readings from sensors and controlling equipment on farms and other outdoor commercial or industrial sites is often difficult due to the large distances involved and lack of infrastructure, such as wired communication lines and electric lines.

### SUMMARY

Disclosed is a mast and radio assembly for remote outdoor use. The mast houses a radio capsule that includes a radio and associated antenna for establishing wireless communications. The mast and a housing of the radio capsule protect the radio and associated antenna from the elements while providing a support to position the antenna at a desired height. The assembly, therefore, may be considered an integrated radio, antenna, radome and mast. The assembly is particularly well suited for outdoor environments where a radio is desired to establish communications between a sensor or piece of equipment and a node in communications network and/or where a radio is desired to provide network infrastructure, such as functioning as a node in a mesh network or other network infrastructure. The assembly is constructed to be easily installed in the ground and, if desired, removed and moved to another site. A battery compartment is easily accessed for changing a battery pack. In some embodiments, a sensor that is co-located with the mast and radio assembly is powered by the battery pack. The mast assembly, and radio and antenna therein, may be increased in height by adding extension sections.

### BRIEF DESCRIPTION OF THE DRAWINGS

FIG. 1 is a schematic diagram of a mast and radio assembly at an installation site with a sensor assembly.

FIG. 2 is an exploded view of the mast and radio assembly without a radio capsule.

FIG. 3 is an exploded view of an extension section of the mast and radio assembly.

FIG. 4 is an exploded view of the radio capsule.

FIG. 5 is a photograph of a front of a representative electronics module that forms part of the radio capsule.

FIG. 6 is a photograph of a rear of the representative electronics module.

FIG. 7 is a photograph of an alternative embodiment of a battery assembly for the mast and radio assembly.

### DETAILED DESCRIPTION OF EMBODIMENTS

Embodiments will now be described with reference to the drawings, wherein like reference numerals are used to refer to like elements throughout. It will be understood that the figures are not necessarily to scale. Features that are described and/or illustrated with respect to one embodiment may be used in the same way or in a similar way in one or more other embodiments and/or in combination with or instead of the features of the other embodiments.

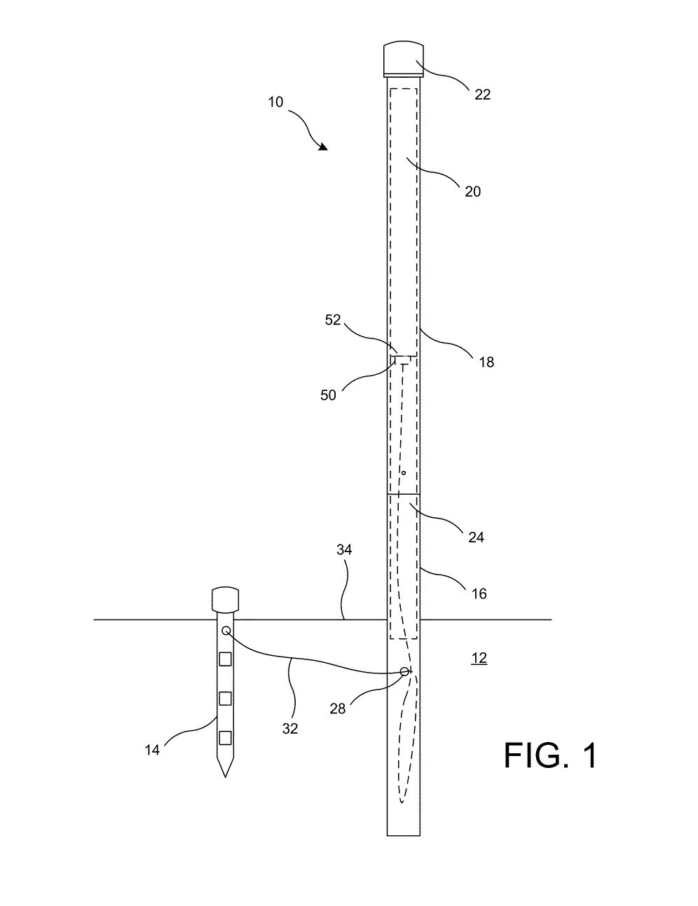

With initial reference to FIG. 1, schematically illustrated is a mast and radio assembly 10 that is installed in the ground 12 at an installation site together with a sensor assembly 14. In the illustrated embodiment, the installation site is at a farm that grows crops and the sensor assembly 14 is a moisture sensor that is installed in the ground 12. In other exemplary embodiments, the mast and radio assembly 10 may be employed at the “sub-master site,” at the “irrigation source,” and/or at the “moisture sensor assembly” as described in U.S. patent application Ser. No. 14/480,691 filed Sep. 9, 2014, the disclosure of which is incorporated herein by reference in its entirety.

The mast and radio assembly 10 may be used in other operational contexts. The installation site may be in a location other than an agricultural farm such as, but not limited to, a livestock farm, an oil well head, a gas well head, a storage vessel, a campus setting, a rail yard, an industrial site, a wildlife monitoring station, or any other setting where wireless communications are desired. Also, the sensor assembly 14 may be any type of sensor, equipment or device. In other embodiments, the mast and radio assembly 10 is installed without an accompanying device and serves as a range-extending node in a wireless network. In one embodiment, the sensor assembly 14 may form part of the mast and radio assembly 10 (e.g., housed by the mast and radio assembly 10 or connected to a surface of the mast and radio assembly 10).

The mast and radio assembly 10 includes a base tube 16, one or more extension sections 18, a radio capsule 20, and a cap 22. The base tube 16, the extension section(s) 18 and the cap 22 form a mast that protects the radio capsule 20 from environmental conditions, such as dust, debris, rain, snow, ice, wind, sunlight, etc. The radio capsule 20 houses an antenna and an associated radio that are used to carry out wireless communications. In addition to protecting the antenna and radio, the mast and radio assembly 10 elevates the antenna to a desired height above the surface of the ground 12, which may be beneficial to the wireless communications.

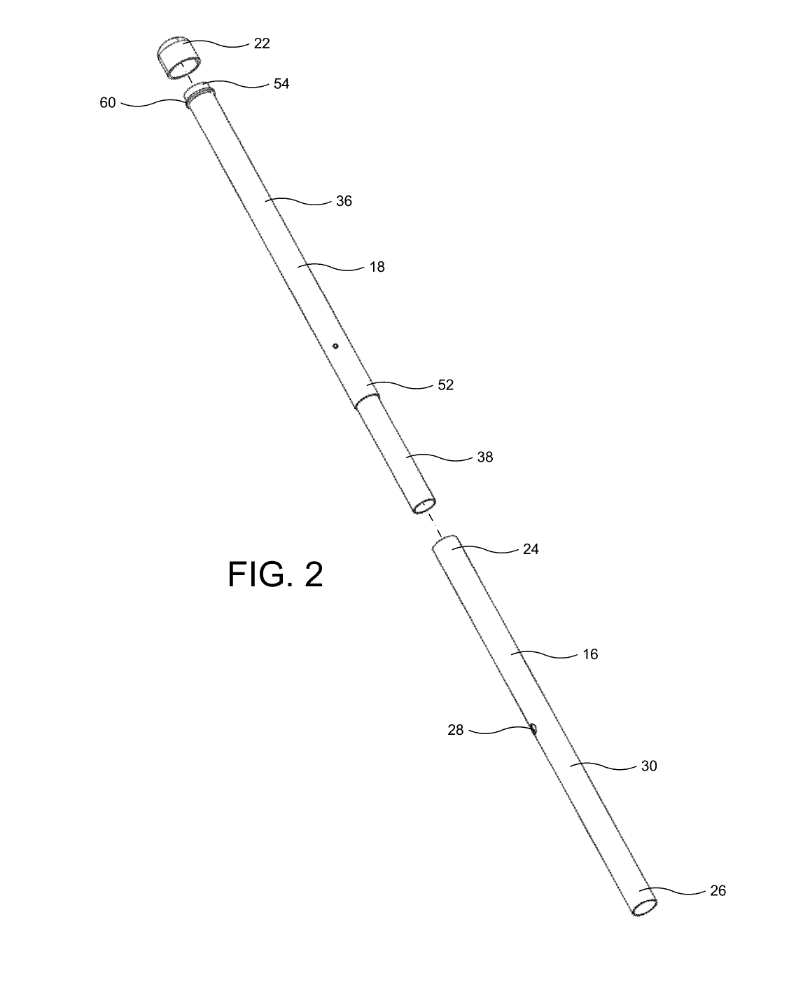

With additional reference to FIG. 2, the base tube 16 is a hollow cylinder that is open at its top end 24. A bottom end 26 may be open or closed. The bottom end 26 may be tapered or form a spike to facilitate insertion into the ground 12. Alternatively, the bottom end 26 may slide or screw into another support element that is first inserted into the ground 12. In another configuration, the bottom end 26 may form an auger to provide “self-drilling” functionality to the base tube 16. In this case, a handle(s) or lever may be used to apply rotational force (e.g., torque) to the base tube 16. The handle may attach to the base tube 16 (e.g., though a transverse hole or notch in the top end 24) or may fold out from the base tube 16.

In a typical installation, the base tube 16 is vertically inserted into the ground 12 to a depth sufficient to support the mast and radio assembly 10 in an upright configuration as shown in FIG. 1 and without the use of cement or other securing structures. In one embodiment, a hole is established in the ground 12 to receive base tube 16. The hole may be established with an auger, fence post digger, or other apparatus. In one embodiment, the hole is established with the same apparatus used to establish a hole for the sensor assembly 14. In other embodiments, the mast and radio assembly 10 may be set in cement or secured to another structure.

The base tube 16 includes a hole or aperture 28 in a sidewall 30 of the base tube 16 between the top end 24 and the bottom end 26. The aperture 28 allows for passage of one or more cables into the mast and radio assembly 10. In the illustrated embodiment, a cable 32 operatively connects the sensor assembly 14 and electronics in the mast and radio assembly 10, as will be discussed in greater detail below. Excess length of the cable 32 may be stored in the base tube 16. The excess length of cable 32 may be used to accommodate extending the height of the radio capsule 20 by adding one or more extension sections 18, as will be discussed in greater detail below.

In one embodiment, the base tube 16 has an inside diameter of 2.25 inches, an outside diameter of 2.5 inches, a sidewall 30 thickness of ⅛th inch and a length of 3.5 feet. The aperture 28 may be 1 inch in diameter and located equidistant between the ends 24, 26. In this document, all sizes and dimensions are exemplary.

In one embodiment, the aperture 28 is positioned to be below a surface 34 of the ground 12 when the base tube 16 is inserted into the ground 12. This allows for at least a portion of the cable 32 extending between the sensor assembly 14 and the mast and radio assembly 10 to be buried (e.g., in a shallow trench). In other embodiments, all or some of the cable 32 extending between the sensor assembly 14 and the mast and radio assembly 10 may be above ground or may be contained in a conduit.

In one embodiment, the base tube 16 may house the radio capsule 20. This may be done, for example, at the early stages of the growing season when crops do not exceed the height of the top end 24. In this case, the extension section 18 may be omitted and the cap 22 may be placed over the top end 24 to keep precipitation, dust and debris out of the base tube 16. In one embodiment, a seal or gasket is present between the cap 22 and the base tube 16. Also, in this configuration, the top end 24 may be elevated above the surface 34 of the ground 12 a sufficient distance to allow for an antenna (discussed below) contained within the base tube 16 to be above the surface 34 of the ground 12. In some cases, however, the elevation of the top end 24 should be low enough to allow for farm equipment to drive over the installed base tube 16 and cap 22. In one embodiment, the installed base tube 16 and cap 22 should not exceed a height of 18 inches. In other embodiments, the base tube 16 may be of a different height (e.g., extend from about 6 inches to about 40 feet above the surface 34 of the ground 12. The base tube 16 may have an internal shoulder or other feature to hold the radio capsule 20 at a desired elevation above the surface 34 of the ground 12. Alternatively, height of the radio capsule 20 relative to the ground 12 may be controlled by interaction of the radio capsule 20 with the upper end of the base tube 16. In these embodiments, the base tube 16 and cap 22 serve as a mast and radome for a radio and antenna located within the radio capsule 20.

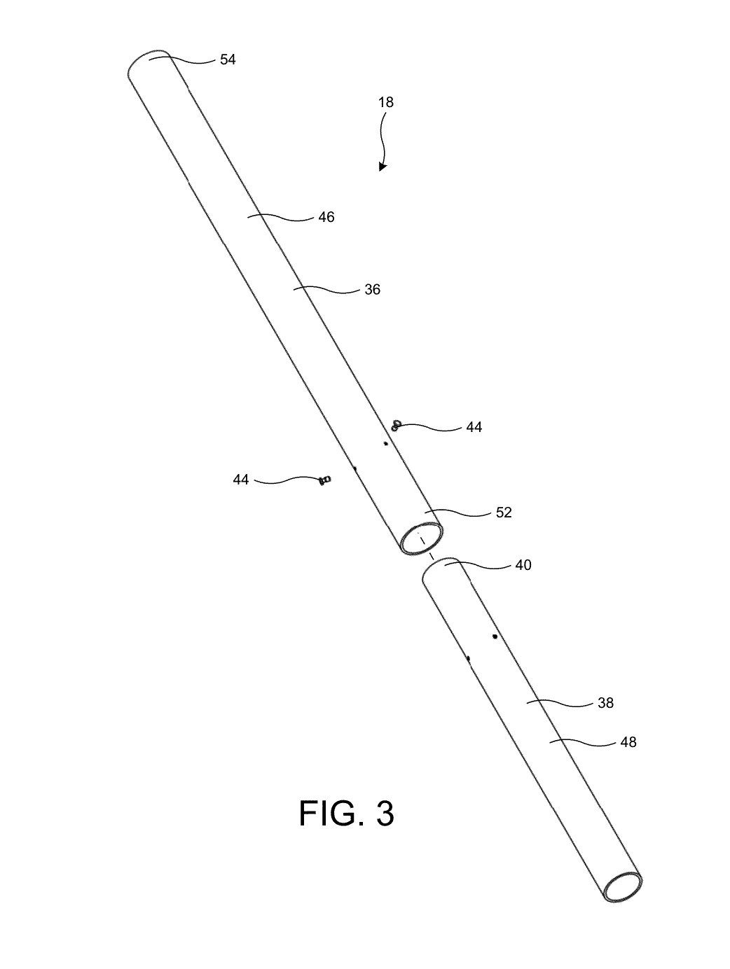

With continued reference to FIGS. 1-3, the extension section 18 includes an extension tube 36 and a coupling tube 38, each of which are hollow cylinders that are open at each end. An upper end 40 of the coupling tube 38 fits in a lower end 52 of the extension tube 36 and is retained thereto with fasteners 44 (e.g., pins, plugs. rivets or screws inserted through mating holes). Alternatively, the extension tube 36 and the coupling tube 38 may be retained together with adhesive, may be of monolithic construction, or may mate by threaded connection between threaded ends of the tubes.

In one embodiment, the extension tube 16 has the same inside diameter, outside diameter and wall thickness as the base tube 16. For instance, the extension tube may have an inside diameter of 2.25 inches, an outside diameter of 2.5 inches, a sidewall 46 thickness of ⅛th inch and a length of 3 feet. In one embodiment, the coupling tube has an inside diameter of 2.0 inches, an outside diameter of 2.25 inches, a sidewall 48 thickness of ⅛th inch and a length of 2 feet. Again, all sizes and dimensions recited in this document are exemplary.

The outside diameter of the coupling tube 38 and the inside diameter of the extension tube 36 are made so that the coupling tube 38 slides easily within the extension tube 36 but has little “play” that would allow for significant relative motion of the parts in a direction transverse to the longitudinal axis of the tubes 36, 38, once assembled. Similarly, the outside diameter of the coupling tube 38 and the inside diameter of the base tube 16 are made so that the coupling tube 38 slides easily within the base tube 16 but has little “play” that would allow for significant relative motion of the parts in a direction transverse to the longitudinal axis of the tubes 36, 38, once assembled.

When fastened in the extension tube 36, an upper portion of the coupling tube 38 is nested inside the extension tube 36. The remainder of the coupling tube 38 (e.g., a lower portion thereof) extends out of the lower end 52 of the extension tube 36. The lower portion of the coupling tube 38 may be inserted into the base tube 16 until the lower end 52 of the extension tube 36 comes to rest against the top end 24 base tube 16. In the embodiment where the coupling tube 38 is about 2 feet long, about 1 foot of the coupling tube 38 may be inside the extension tube 36 and about 1 foot of the coupling tube 38 may be inside the base tube 16. Additional fasteners may be used to secure the coupling tube 38 to the base tube 16, but it is contemplated that the extension section 18 will remain suitably positioned on top of the base tube 16 by the force of gravity. Other securing techniques may be employed. For example, the coupling tube 38 and the base tube 38 may mate by threaded connection between threaded ends of the tubes. In one embodiment, one or more of the tubes 16, 36, 38, or the radio capsule 20, may be keyed or have a flat section so as to minimize rotational movement of the tubes 16, 36, 38 and/or radio module 20 relative to one another. In another embodiment, the top end 24 of the base tube 16 and the lower end 52 of the extension tube 36 have intermeshing configurations to minimize relative rotation with respect to one another. Exemplary intermeshing configurations include saw tooth patterns and crenelated patterns. Another securing technique includes using resilient detents, non-resilient detents or spring loaded buttons that are located on one tube element and that are captured by holes, recesses or slots on another one of the tube elements. For instance, radial pins may engage and lock into “L” shaped slots when axially slid and then rotated into a locked position.

The cable 32 may be feed though the tubes 36, 38 of the extension section 18 (before or after assembly with one another and/or before or after mating of the extension section 18 with the base tube 16) and a connector 50 at an end of the cable 32 may be connected to a mating connector (discussed below) at a lower end 52 of the radio capsule 20. Then, the radio capsule 20 is inserted into extension tube 36 at an upper end 54 thereof. The radio capsule 20 slides into the extension tube 36 until the lower end 52 of the radio capsule 20 rests against the upper end 40 of the coupling tube 38. In other embodiments, downward movement of the radio capsule 20 may be limited by a shoulder inside the extension tube 36, with fasteners, or by interaction of the radio capsule 20 with the upper end 54 of the extension tube 36.

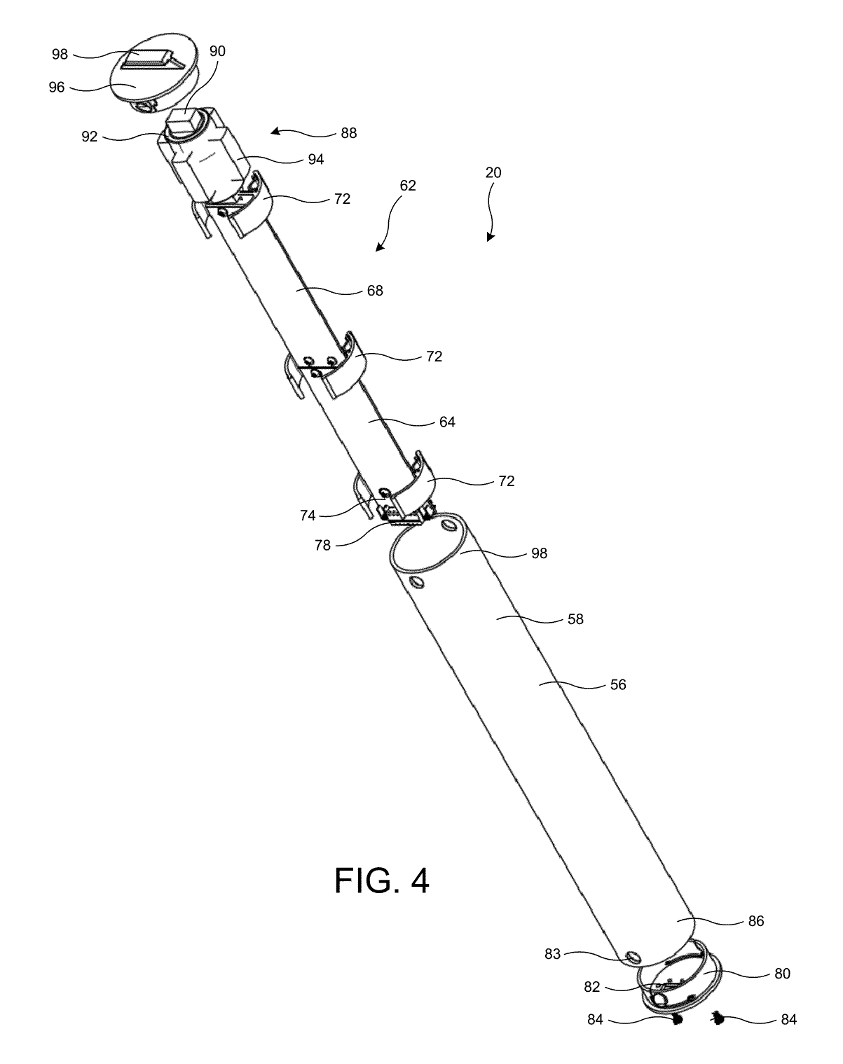

With additional reference to FIG. 4, an outside diameter of the radio capsule 20 is primarily defined by a housing tube 56. The outside diameter of the housing tube 56 and the inside diameter of the extension tube 36 are made so that the radio capsule 20 slides easily within the extension tube 36 but has little “play” that would allow for significant motion of the radio capsule 20 in a direction transverse to the longitudinal axis of the extension tube 36, once assembled. In one embodiment, the housing tube 56 has an inside diameter of 2.0 inches, an outside diameter of 2.25 inches, a sidewall 58 thickness of ⅛th inch and a length of 2 feet.

The cap 22 may be placed on the upper end 54 of the extension tube 36. In one embodiment, the cap is a hollow cylindrical body that is open at a bottom end thereof and closed at a top end thereof. The inside diameter of the cap 22 may be sized so that the cap tightly fits over the outside diameter of the extension tube 36, but is removable therefrom. In one embodiment, the cap 22 is secured to the extension tube 36 with fasteners or the cap 22 screws directly onto a threaded upper end of the extension tube 36. In one embodiment, a seal or gasket is present between the cap 22 and the extension tube 36. In the illustrated embodiment, a collar 60 is placed on or is integral with the outside of the extension tube 36 and serves as a positioner for the cap 22.

The base tube 16, the extension tube 36, the coupling tube 38, the housing tube 56 and the cap 22 are preferably made from a non-ferrous, non-conducting and RF energy transparent material to allow RF signals to propagate through these parts without significant attenuation. An exemplary material for this purpose is fiberglass. As will be described, a radio and antenna assembly 62 may be housed in the housing tube 56 of the radio capsule 20, which is, in turn, housed in the extension tube 36 that has its upper end 54 covered by the cap 22. In this arrangement, the extension section 18, the base tube 16 and cap 22 function as a mast to raise the height of the radio and antenna assembly 62 and function as a radome for the radio and antenna assembly 62 by protecting the radio and antenna assembly 62 from the elements.

The height of the radio and antenna assembly 62 may be increased by adding an extension section 18. This may be done by removing the cap 22 and then removing the radio capsule 20. Next, the cable 32 is disconnected from the radio capsule 20. The cable 32 is fed through an additional extension section 18 and reconnected to the radio capsule 20. Then the portion of the coupling tube 38 extending from the extension tube 36 of the additional extension section 18 is inserted into the existing extension tube 36. Then the radio capsule 20 is inserted into the additional extension tube 36 and the cap 22 is placed on the additional extension tube 36. As many extension section 18 may be used as is desired so long as the height of the mast and radio assembly 10 remains structurally sound, including maintaining stability of the base tube 16 in the ground 12. Each extension section 18 forming part of the mast and radio assembly 10 may be constructed in the same manner or in a manner similar to each other. Various extension sections 18 may be of different lengths.

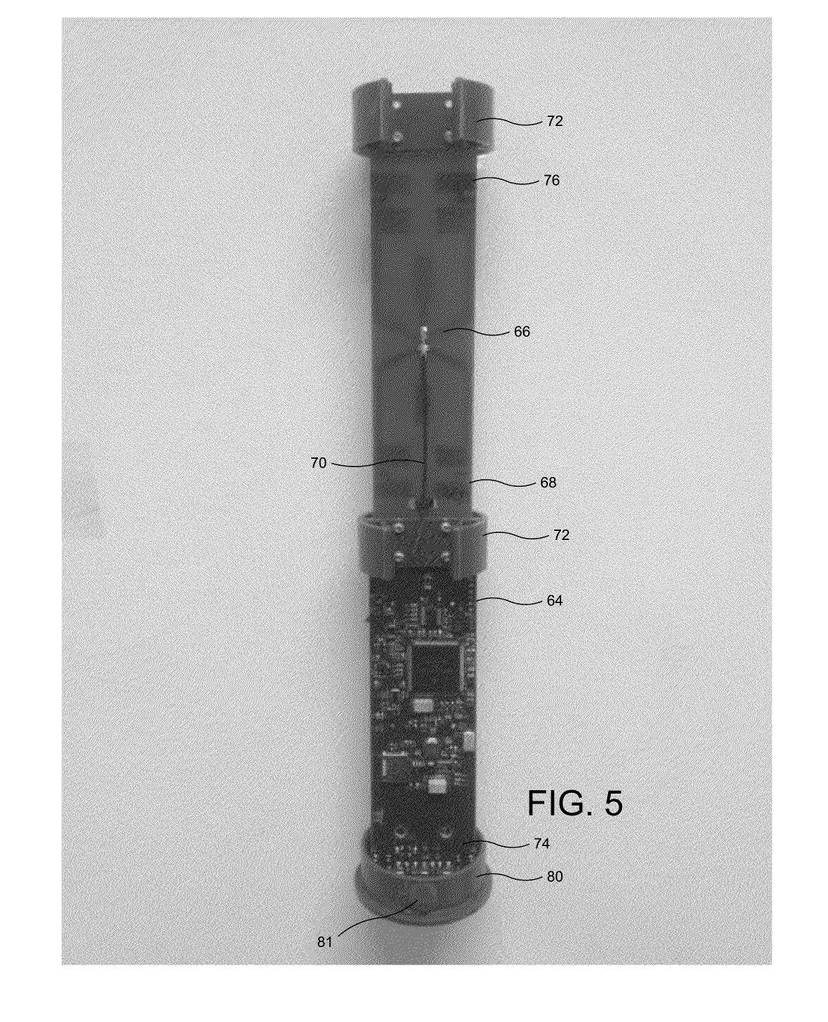

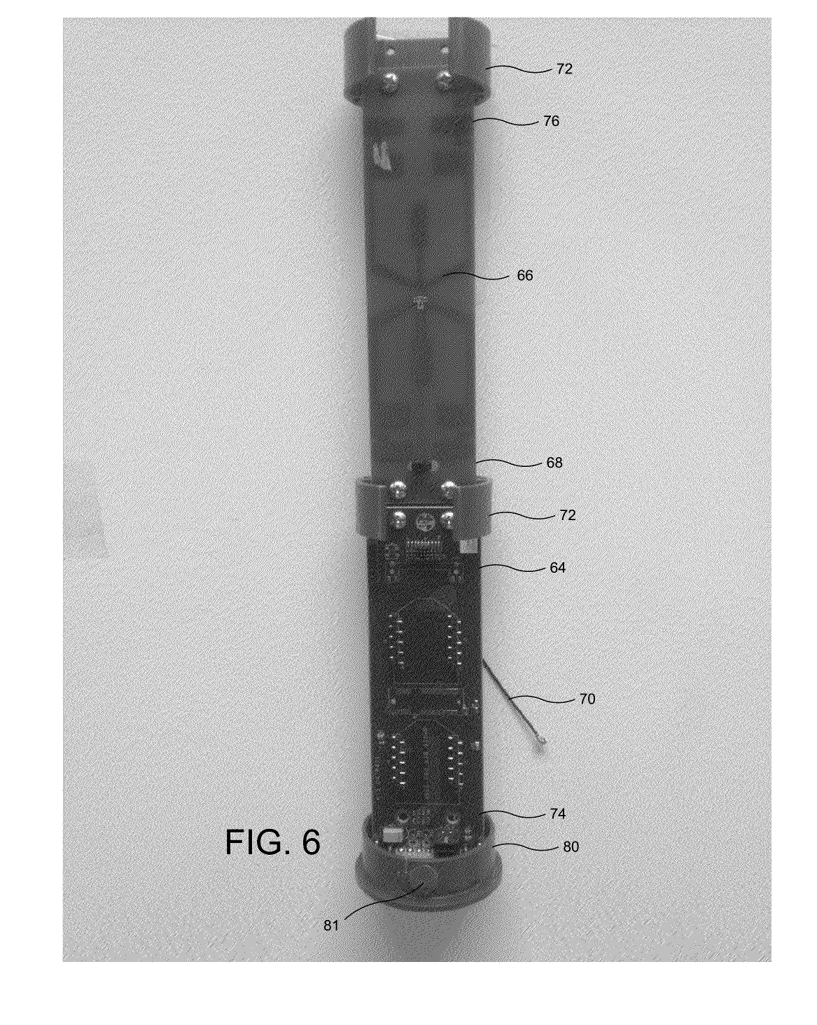

With reference to FIGS. 4-6, the radio capsule 20 will be described in greater detail. The radio capsule 20 includes the radio and antenna assembly 62 (e.g., electronics module) that is inserted into the housing tube 56. In the illustrated embodiment, the radio and antenna assembly 62 includes a radio 64 and an antenna 66. The radio 64 is embodied as a printed circuit board and associated electronic circuitry. Therefore, the radio 64 of the illustrated embodiment may be referred to as a “radio board” and may include components (e.g., control circuitry, processors, memory, etc.) that carry out functions in addition to wireless communications. The antenna 66 may be a low-profile antenna (e.g., a printed circuit board antenna) that is secured to a substrate 68 with adhesive. The substrate 68 may be made of plastic, such as ABS. An RF cable 70 may operatively couple the antenna 66 and the radio 64, although the RF cable 70 is disconnected from the radio 64 in FIGS. 5 and 6. The antenna 66 may have other physical arrangements, but will typically be contained in the mast and radio assembly 10. In other embodiments, at least a portion of the antenna 66 is located outside the mast and radio assembly 10 and is exposed to the elements. In this case, the antenna 66 or a cable connecting the antenna 66 to the radio 64 may protrude through the cap 22 or the extension tube 36.

In the illustrated embodiment, the radio and antenna assembly 62 is connected to retainer clips 72. The clips 72 may be secured to the substrate 68 and the printed circuit board of the radio 64 with fasteners, such as machine screws and nuts. The clips 72 include wings that form circular sections and, when inserted into the housing tube 56, contact an inner surface of the housing tube 56 to retain the radio and antenna assembly 62 in place. In the embodiment of FIG. 4, a first clip 72 is present at a lower end 74 of the radio 64, a second clip 72 is present at an upper end 76 of the substrate 68, and a third clip 72 may be present at the center of the radio and antenna assembly 62. The third clip 72 may attach to both the substrate 68 and the radio 64 to hold the substrate 68 and the radio 64 in fixed relationship to one another. The clips 72 may include longitudinal passages or other features to aid in cable management. The first clip 72 at the lower end 74 of the radio 64 is omitted in FIGS. 5 and 6.

A connector 78 for interfacing with the connector 50 of the cable 32 may be present at the lower end 74 of the radio 64. Depending on cabling supplied with the sensor assembly 14, the connector 50 may be field installed on the cable 32. In other situations, an adapter may be interposed between the connector 50 and the connector 78 to establish an operative connection between the radio 64 and the sensor assembly 14. In an alternative embodiment, the radio 64 may include a pigtail cable and connector that interfaces with the cable 32 and connector 50. In still other embodiments, the radio 64 may include multiple connectors 78 or a bus for interfacing with multiple sensors or electronic devices. In other embodiments, the radio 64 may communicate wirelessly with the sensor assembly 14 or another nearby device, such as over a Bluetooth interface.

A lower end cap 80 may cover a lower end of the housing tube 56. The lower end cap 80 may include a passage 82 through which the connector 78 protrudes or is accessible. The end cap 80 may have a cylindrical portion that fits within the housing tube 56 and an end wall, as illustrated. The end cap 80 may secure to the housing tube 56 with resilient members 81 that are received in corresponding openings 83 in the housing tube 56. Alternatively, the end cap 80 may be secured by friction fit, threaded connection, fasteners, coordinating indents and detents, or other appropriate structure. In one embodiment (e.g., as shown in FIGS. 5 and 6), the lower end cap 80 is secured to the radio 64 with fasteners 84, then the radio and antenna assembly 62 is inserted into the housing tube 56 via an open lower end 86 of the housing tube 56.

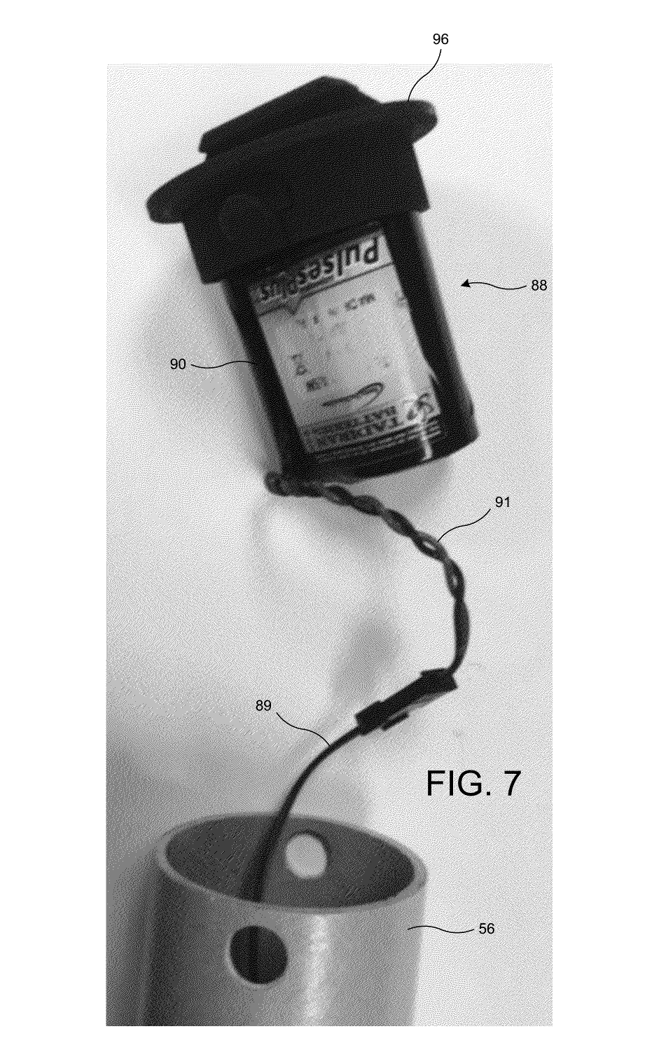

In one embodiment, the radio and antenna assembly 62 includes a source of power, such as a battery assembly 88. The battery assembly 88 may connect to the radio 64 by way of a cable 89 (FIG. 7). In one embodiment, the battery assembly 88 may supply operational power to the sensor assembly 14 by way of the cable 32 or a separate power cable.

In the illustrated embodiment, the battery assembly 88 includes a battery pack 90 containing battery cells. The battery pack is contained in a sleeve 92. The sleeve 92 may be part of or connected to the upper clip 72 and/or the substrate 68. The sleeve 92 may be surrounded with a structure 94 that consumes space between the sleeve 92 and the housing tube 56 and minimizes excessive movement of the sleeve 92 and battery pack 90. In one embodiment, the structure 94 is compliant. An exemplary compliant material for the structure 94 is foam, but the structure 94 may be made from more rigid material and/or combined with the sleeve 92.

An upper end cap 96 may cover an upper end 98 of the housing tube 56. The upper end cap 96 may have a cylindrical portion that fits within the housing tube 56 and an end wall, as illustrated. Similar to the lower end cap 80, the end cap 96 may secure to the housing tube 56 with resilient members that are received in corresponding openings in the housing tube 56. Alternatively, the end cap 96 may be secured by friction fit, threaded connection, fasteners, coordinating indents and detents, or other appropriate structure. In one embodiment, the upper end cap 96 is secured to the radio and antenna assembly 62 with fasteners.

The upper end cap 96 preferably includes a handle 98 that may be grasped by a hand of a user or a tool to facilitate removal of the radio capsule 20 from the extension tube 36 by pulling along the common longitudinal axis of the radio capsule 20 and extension tube 36.

From time to time, the battery pack 90 may be removed for recharging or for replacement with a charged battery pack 90. To carry out this process, a user may remove the cap 22 and then at least partially remove the radio capsule 20 from the extension section 18. Next, the cap 96 may be removed and the battery pack 90 is removed from the sleeve 92, which disengages a physical connection between electrical contacts of the battery pack 90 and mating electrical contacts inside the sleeve 92. The mating electrical contacts inside the sleeve 92 may be part of an electrical pathway between the battery pack 90 and the radio 64.

A charged battery pack 90 or the original battery pack 90, following recharging, may be inserted into the sleeve 92 and physical connection between electrical contacts of the battery pack 90 and mating electrical contacts inside the sleeve 92 may be re-established. Then the cap 96 may be placed back on the housing tube 56. In one embodiment, the cap 96 includes a member or has sufficient thickness when the radio capsule 20 is assembled to force the contacts of the battery pack 90 to remain in physical connection with the contacts in the sleeve 92. In other embodiments, the contacts of the battery pack 90 and the contacts in the sleeve 92 are male and female components of mating connectors to maintain connection between the sets of contacts. Once the cap 96 is returned to its position, the radio capsule 20 may be returned to its position in the extension section 18 and the cap 22 may be returned to its position on the extension section 18. In other embodiments, the battery pack 90 may be removed and replaced without removing the radio capsule 20 from the extension section 18.

The clips 72, cap 80, cap 96 and sleeve 92 may be made from a suitable plastic material, such as ABS.

FIG. 7 shows another embodiment of the battery assembly 88. In this embodiment, the battery pack 90 is secured to a lower side of the cap 96, such as with adhesive, hook and look fastener, screws, or another type of fastener. In this embodiment, the sleeve 92 and the structure 94 may be omitted. In this embodiment, leads 91 that extend from the battery pack 90 connect to the cable 89 via mating connectors as shown. In one embodiment, a spacer is inserted in the housing tube 56 between the battery pack 90 and the upper end of the radio and antenna assembly 62.

Since the battery pack 90 is secured to the cap 96, the battery pack 90 may be removed from or put into the housing tube 56 by removing the cap 96 from the housing tube 56 or connecting the cap 96 to the housing tube 56, respectively. To replace the battery pack 90, the cap 96 and battery pack 90 may be removed from the housing tube 56, the leads 91 may be disconnected from the cable 89, the battery pack 90 may be removed from the cap 96, a new or recharged battery pack 90 may be secured to the cap 96, the leads 91 may be connected to the cable 89, and the cap 96 with battery pack 90 may be reconnected with the housing tube 56. In another embodiment, the cap 96 and battery pack 90 are not easily separable from one another. In this case, replacement of the battery pack 90 may include replacement of the cap 96.

The radio and antenna assembly 62 may be configured to operate over cellular bands and protocols, WiFi bands and protocols, Bluetooth bands and protocols, and/or any other suitable bands and protocols for carrying out the communication functions of the radio and antenna assembly 62. Additionally, the radio 64 may include functionality for interfacing with and processing information from the sensory assembly 14 or any other connected electronic device.

As will be appreciated, various modifications may be made to the mast and radio assembly 10. For example, the mast and radio assembly 10 may be used to support and/or protect additional items. One exemplary additional item that may be supported by the mast and radio assembly 10 is a solar panel used to recharge the battery pack and/or supply operational power. The solar panel may be fixed relative to the mast and radio assembly 10 or may be configured to track the location of the sun. In an embodiment that includes a solar panel, it may be desirable to include features that minimize rotation of the tube elements relative to one another so that wind acting on the solar panel does not cause rotation of the tube elements relative to one another and turn the solar panel away from the sun. Other additional items that may be supported by the mast and radio assembly 10 include, but are not limited to, monitoring equipment, such as weather monitoring equipment for monitoring temperature, wind speed, barometric pressure, precipitation, etc.

Although certain embodiments have been shown and described, it is understood that equivalents and modifications falling within the scope of the appended claims will occur to others who are skilled in the art upon the reading and understanding of this specification.

What is claimed is:

1. A mast and radio assembly, comprising:
a mast formed from one or more hollow elongate members; and
a radio capsule housing a radio and antenna assembly, the radio capsule completely insertable into the mast for protection from environmental conditions, and the mast holding the radio capsule at a desired height above a surface of the ground for wireless communications.

2. The mast and radio assembly of claim 1, wherein a lower portion of the mast is directly insertable into the ground.

3. The mast and radio assembly of claim 2, wherein the mast comprises as least two vertically stacked elongate members.

4. The mast and radio assembly of claim 1, wherein the mast comprises as least two vertically stacked elongate members.

5. A mast and radio assembly, comprising:
a base tube vertically insertable into the ground;
an extension section supported by the base tube at a height vertically above the base tube; and
a radio capsule housing a radio and antenna assembly, the radio capsule completely insertable into the extension section, the radio and antenna assembly protected from environmental conditions and held at a desired height above a surface of the ground for wireless communications by the extension section.
